(19) United States
(12) Patent Application Publication
(10) Pub. No.: US 2024/0196819 A1
(43) Pub. Date: Jun. 20, 2024

(54) IRRIGATION SYSTEM

(71) Applicants: Michael SIEMSEN, Delmenhorst (DE); Krzysztof LASAK, Dünsen (DE)

(72) Inventor: Krzysztof LASAK, Dünsen (DE)

(73) Assignees: Michael SIEMSEN, Delmenhorst (DE); Krzysztof LASAK, Dünsen (DE)

(21) Appl. No.: 18/288,126

(22) PCT Filed: Apr. 25, 2022
(86) PCT No.: PCT/EP2022/060872

§ 371 Date: Nov. 14, 2023

(30) Foreign Application Priority Data
Apr. 24, 2021 (DE) 20 2021 001 521.3

(51) Int. Cl. A01G 27/04; A01G 9/02

(52) U.S. Cl. CPC A01G 27/04; A01G 9/025

(57) ABSTRACT

An irrigation system for vertical planting systems has at least one water storage container arranged vertically above the vegetation body, and at least one capillary-active water conductor arranged therein, which protrudes from the water storage container and protrudes into the vegetation body.

The present invention relates to an irrigation system for vertical greenery inside and outside of buildings, consisting of at least one water storage container and a novel water supply system.

The innovative irrigation system is suitable for wall/facade-bound greenery as well as for free-standing vertical greenery, e.g. suitable as a room divider.

The greening of building surfaces has become widespread, particularly with regard to the installation of horizontal greening systems, from a design and urban climatic point of view.

The structure of the growth layer and the natural amounts of precipitation and their distribution during the growing season often allow vegetation systems to remain viable without additional irrigation. However, there are often limits to vertical greenery on buildings, as they do not prove to be sufficiently viable without long-term, stable irrigation.

Among the irrigation systems, the best known are hose-connected systems, in which water distribution and dosage is achieved by drip irrigation.

Such an irrigation system is described in DE102013107786. In practice, such systems often prove to be prone to failure. The blockage of individual irrigation nozzles leads to an undersupply of the vegetation and even to total failure in the relevant underlying vertical vegetation segments. In addition, the pressure distribution in the irrigation hoses can lead to significant differences in water dosage per unit area and thus lead to a non-uniform growth pattern.

In DE102013109821 it is proposed to implement irrigation for vertical greening using a nozzle pipe that moves up and down.

An irrigation system described in DE102018129987 is similarly complex, in which the vegetation to be irrigated is divided into several vertically stacked sections and each section is assigned a separate water reservoir with nozzles piped into the vegetation support. Both systems are extremely complex both in terms of material and costs.

The object of the present invention is to propose an irrigation system for vertical greenery that is characterized by a simple design and also has a high level of operational reliability.

The task is solved by the features mentioned in claim 1.

According to the invention, the device for irrigating vertical greenery has at least one water storage container arranged vertically above a body of vegetation and at least one capillary-active water conductor arranged therein.

The at least one capillary-active water conductor projects out of the water storage container and into the vegetation body. Consequently, the water reservoir for irrigation is located above the body of vegetation.

Although the terms irrigation, water tank and aquifer are used in the description, it is intended to be clear that any medium other than water that can perform the same task is also included.

A first aspect of the invention relates to a device for irrigating vertical planting systems—so-called vegetation bodies. The device for irrigation should be designed to be attachable to any vegetation body and thus be flexible for different vegetation bodies. For example, it is also possible to retrofit an existing body of vegetation with the irrigation device.

A further aspect of the invention relates to a vegetation body with a device for irrigation, in which case the device for irrigation is provided with a fixed or reversible connection to the vegetation body.

The following statements should therefore apply to both the first and second aspects of the invention.

The irrigation device preferably has only a single water storage container.

If a plurality of water storage containers is provided within the irrigation device, the water storage containers are preferably provided at similar height within the irrigation device.

Preferably, a single capillary-active water conductor is used for the irrigation device.

In one embodiment, however, the irrigation device can also have a plurality of capillary water conductors.

For example, the vegetation body can be provided as a room divider, with both longitudinal surfaces of the room part being covered with different greenery. In such a case, it can be advantageous to choose different capillary-active water conductors for the longitudinal surfaces if the plants selected have different water requirements on each longitudinal side. When planting plants with a high water requirement, this is done for them on the long side, for example, a capillary-active water conductor with a high capillary effect (high suction strength or strongly absorbent) was chosen. If the other long side is planted with plants that require little water, a capillary-active water conductor with a low capillary effect (low suction strength) is selected for this side. Advantageously, the irrigation device can therefore be flexibly adapted to the planting of a body of vegetation.

In one embodiment of the irrigation device, the at least one capillary-active water conductor has a length that corresponds to less than a third of the height (length in the vertical direction) of the vegetation body.

The at least one capillary-active water conductor can be arranged in such a way that it projects into the vegetation body from above to less than a first third of the height of a vegetation body. This means that the at least one capillary-active water conductor only extends a short distance into the vegetation body and is in contact there within the vegetation body, for example with the plant substrate (fleece mat, folded fleece). For example, the at least one capillary-active water conductor can be only 5 to 10 cm, preferably 3 to 15 cm, particularly preferably 2 to 30 cm and most preferably 1 to 70 cm. The at least one capillary-active water conductor projects into the vegetation body if at least a portion of the capillary-active water conductor extends over the side edges of the vegetation body into the vegetation body. If the at least one capillary-active water conductor only extends into the vegetation body in the required manner, it is advantageously possible to replace the capillary-active water conductor without damaging the greenery or the substrate of the greenery.

For example, the material described in European patent EP 3337922, which is hereby incorporated as reference, can be used as a substrate and/or as a capillary-active water conductor. In another embodiment of the irrigation device, the at least one capillary-active water conductor has a length that corresponds to the length of the vegetation body in the vertical direction. As a result, the at least one capillary-active water conductor can run over the entire length of the vegetation body within the vegetation body. In one embodiment of the device, the capillary water conductor is selected so that it not only serves as a capillary-active water conductor, but also as a substrate for the plants. This creates a simple structure, which in particular simplifies later recycling (fewer material components).

In one embodiment of the device for irrigation, the at least one capillary-active water conductor has a width that corresponds to the width of the vegetation body, the at least one capillary-active water conductor protruding into the vegetation body over the entire width of the vegetation body with the entire width of the at least one capillary-active water conductor.

In this way, water can be released advantageously over the entire width of the vegetation body through the at least one capillary-active water conductor. This makes it easier to distribute water evenly and does not have to be distributed over the substrate, or only to a lesser extent. Advantageously, the requirement for the substrate (plant substrate) is lower, since the substrate does not have to ensure a flat distribution of water extending over the width of the vegetation body. Since the vertical distribution of water is advantageously simplified by gravity, a substrate can also be selected which itself has almost no or only little capillary properties. This increases the choice of substrates and can be more closely aligned with the root properties of the plants and their retention in the substrate.

Preferably, the length and width of the at least one capillary-active water conductor can be adapted to a body of vegetation.

For example, the at least one capillary-active aquifer can be trimmed so that its length and width matches the body of vegetation and the application. Retrofitting an existing body of vegetation with the irrigation device is thus easily possible.

In a further embodiment of the irrigation device, the at least one capillary-active water conductor is arranged in the irrigation device in such a way that at least a portion of the at least one capillary-active water conductor protrudes neither into a body of vegetation nor into the at least one water storage container.

This should be understood to mean that the at least one capillary-active water conductor has a portion that is free and is not located within the water storage container and not within a body of vegetation. However, this free portion of the at least one capillary-active water conductor can be covered by a protective cover. Because a portion of the at least one capillary-active aquifer is not arranged within the water storage container and a vegetation body, it is possible to easily check the functionality of the irrigation device by checking the moisture level of the at least one capillary-active aquifer. This makes it easy to check and, for example, detect whether the water storage container is empty without having to check the fill level from above. Furthermore, fertilization of the plant can also advantageously take place via the free portion of the at least one capillary-active water conductor by applying the fertilizing medium (nutrient substrate) in liquid form to this free portion.

This means that the fertilizing medium does not have to be inserted into the at least one water storage container, where it may remain for longer and, for example, there may be greater growth of algae in the water storage container. Preferably, the at least one capillary-active water conductor is a geotextile fleece with a grammage of 50 to 2500 g/m², more preferably 800 g/m². In one exemplary embodiment, the device for irrigation has at least two capillary-active water conductors, the at least two capillary-active water conductors being of different grammage. Preferably, the mutually different capillary-active water conductors can be arranged on different long sides of a vegetation body, so that the different long sides of a vegetation body can be planted with plants with different water requirements.

In one embodiment of the irrigation device, the irrigation device has a protective cover and the at least one water storage container and at least partially the at least one capillary-active water conductor are covered by the protective cover.

The protective cover can advantageously prevent insects or dirt from contaminating the at least one water storage container or the exposed part of the at least one capillary-active water conductor. For example, it can advantageously be prevented that mosquito larvae, for example, grow in the at least one water storage container.

In a further embodiment of the irrigation device, the protective cover is movably provided on a body of vegetation.

In this context, movable means that the protective cover can be moved reversibly relative to a body of vegetation. In one embodiment, the protective cover is designed in such a way that a kind of closed hood is created over the water storage container up to the vegetation body, so that contamination or unwanted manipulation of the irrigation medium can be prevented. Thanks to the reversible movable design of the protective cover it is made easy to maintain and refill the device (water storage container).

In one embodiment of the irrigation device, the irrigation device has a collecting tray which can be arranged at the foot of a body of vegetation or on which a body of vegetation stands.

The collecting tray can collect the excess irrigation fluid (irrigation medium) of the irrigation device. The shape of the collecting tray is preferably adapted to the shape of the protective cover, so that a uniform overall impression is created.

In one embodiment, the protective cover and the collecting tray together with covers on the long side of a vegetation body form a frame, so that the irrigation device can be arranged as a frame around a vegetation body.

In one embodiment of the irrigation device, the irrigation device has at least one pump which pumps the irrigation fluid from the collecting tray into the water storage container (back or into it for the first time).

In this way, an irrigation circuit can be formed so that the water storage container has to be refilled less often and the drip tray does not have to be removed or only rarely has to be removed.

Preferably, the pump is positioned in the collecting tray and directs the irrigation medium back into the water storage container via a hose system that runs inside a body of vegetation or outside a body of vegetation. A hose system that runs outside a vegetation body is preferably arranged inside the panels on the long side of the vegetation body and is therefore not visible to a viewer of the vegetation body. In one embodiment of the irrigation device, the at least one capillary-active water conductor is a one-piece textile material, the two ends of which are connected to one another. A one-piece textile material is present if the textile material does not consist of a plurality of parts that have been joined together to form a textile material, for example by sewing and/or gluing. A one-piece textile material is, for example, a nonwoven material made from one piece. Preferably, the two ends of the one-piece textile material are connected to one another by sewing.

The connection creates a kind of loop that can run through the water storage container and at least through a part of a vegetation body.

In one embodiment of the irrigation device, the at least one water storage container and/or the protective cover and/or the at least one capillary-active water conductor can be reversibly removed from the irrigation device.

Reversibly removable means that the corresponding parts of the device can be removed from or from the device without the device being destroyed and the corresponding (new) parts can be reinserted into the device without destroying the device.

Preferably, the entire irrigation device and/or the at least one water storage container and/or the protective cover and/or the at least one capillary-active water conductor can also be reversibly removed from a body of vegetation.

In one embodiment of the irrigation device, the removal of the removable parts is possible by a horizontal movement of the removable parts parallel to the width of a body of vegetation.

The parts to be removed are preferably moved parallel to the width of the vegetation body and can thus be removed from the device. For this purpose, the vegetation body can have guide rails on the housing of the vegetation body, which simplify removal.

In another embodiment, the removable parts can also be provided connected to a vegetation body by means of Velcro and/or magnetic connection.

In one embodiment of the irrigation device, the device has at least one capillary-active bridge.

A capillary-active bridge is a capillary-active water conductor that can be used to transport irrigation medium.

The at least one capillary-active bridge preferably consists of a textile material and particularly preferably of a geotextile nonwoven material. In one embodiment, the geotextile nonwoven material of the at least one capillary-active bridge has a grammage of 50 to 2500 g/m², more preferably 800 g/m². In a special embodiment, the at least one capillary-active bridge consists of the same geotextile nonwoven material as the at least one capillary-active water conductor. With the at least one capillary-active bridge, it is advantageously possible to irrigate a plurality of vegetation bodies with just a single irrigation device. The different vegetation bodies can be arranged vertically one below the other and/or horizontally next to one another. This makes it advantageously possible to expand or reduce the vertical planting as desired by simply attaching or dismantling additional vegetation bodies. By using a textile material as a capillary-active bridge, the capillary-active bridge is particularly flexible and flexible, so that an arrangement of vegetation bodies in curves and curvatures relative to one another is possible, with the capillary-active bridges preferably connecting vegetation bodies arranged vertically one below the other.

In such a case, the device for irrigation can be provided on an easily accessible body of vegetation, whereas the remaining vegetation bodies can be arranged anywhere around it. There is therefore a lot of scope for design when arranging the vegetation bodies with many design options (for example, vertically green, curved room dividers are also possible).

In one embodiment of the device for irrigation with at least one capillary-active bridge, the at least one capillary-active bridge is arranged outside the vegetation bodies.

The at least one capillary-active bridge can, for example, be arranged below a first vegetation body (for example in a collecting tray of the first vegetation body) and above a further vegetation body, without the at least one capillary-active bridge or portions of the at least one capillary-active bridge extending into the vegetation body. In this embodiment, the irrigation medium that has left the first vegetation body is guided through the at least one capillary-active bridge, preferably above the further vegetation body, where the irrigation medium can then drip or flow, for example, into the further vegetation body. Depending on the design of the further vegetation body, it is of course also possible for the at least one capillary-active bridge to guide the irrigation medium to the lower region of a further vegetation body (for example into the collecting tray of the further vegetation body), provided that the further vegetation body is suitable for receiving irrigation medium from below (for example, in that the substrate (e.g. pleated fleece, pleated mat) of the further vegetation body is capillary active and extends into the collecting tray of the further vegetation body).

If the at least one capillary-active bridge is designed in such a way that the at least one capillary-active bridge does not extend into the vegetation bodies, the connection of different vegetation bodies to the device for irrigation through the capillary-active bridge remains particularly flexible. An exchange of a bridge connection can be done easily without interfering with a body of vegetation. In the case of large-scale vertical greening, for example, two or more irrigation devices can be provided, which irrigate at different rates by choosing different capillary-active water conductors. A connection of a new vegetation body to one of the two irrigation devices and also a change between the two irrigation devices is possible without intervening in the vegetation body (and thus without damaging the plants).

In one embodiment of the device for irrigation with at least one capillary-active bridge, the at least one capillary-active bridge is at least partially arranged within a body of vegetation.

For example, the at least one capillary-active bridge can be arranged below a first vegetation body (for example in its collecting tray) and be in direct (physical) contact with the substrate (for example folded fleece, folded mat) of the further vegetation body. In this case, at least a portion of the at least one capillary-active bridge projects into the further body of vegetation. However, the at least one capillary-active bridge can also be in direct contact with the substrate of the first vegetation body and at the same time in direct contact with the substrate of the further vegetation body, so that the at least one capillary-active bridge projects into both vegetation bodies. Preferably, the contact between the at least one capillary-active bridge and the substrate occurs by attaching the material of the capillary-active bridge to the substrate (sewing, gluing, needling, twisting, matting). The linear insertion (or direct contact with the substrates) of the at least one capillary-active bridge into one or more vegetation bodies has the advantage that a particularly stable connection can be achieved, which still ensures reliable irrigation even with a slight movement of the vegetation bodies relative to one another.

A further subject of the present invention relates to a vertically plantable vegetation body having at least one irrigation device as described above. The vegetation body according to the invention therefore has at least one water storage container which is arranged vertically above the vegetation body and at least one capillary-active water conductor which protrudes from the water storage container and into the vegetation body. Furthermore, depending on the embodiment, the vegetation body can have at least one protective cover and/or at least one collecting tray and/or at least one pump and/or at least one hose system and/or at least one cover. In addition, the vegetation body can have one or more capillary-active bridges, whereby further vegetation bodies can be connected to the vegetation body and the device for irrigation (the vegetation body is therefore expandable). All statements regarding the irrigation device should also apply to the vertically plantable vegetation body with the corresponding irrigation system.

The invention is explained in more detail below using figures, the figures merely representing embodiments of the invention.

### SHORT DESCRIPTION OF THE FIGURES

FIG. 1: Irrigation device for vertical greenery.

FIG. 2: Irrigation device with a plurality of vegetation bodies and a capillary-active bridge

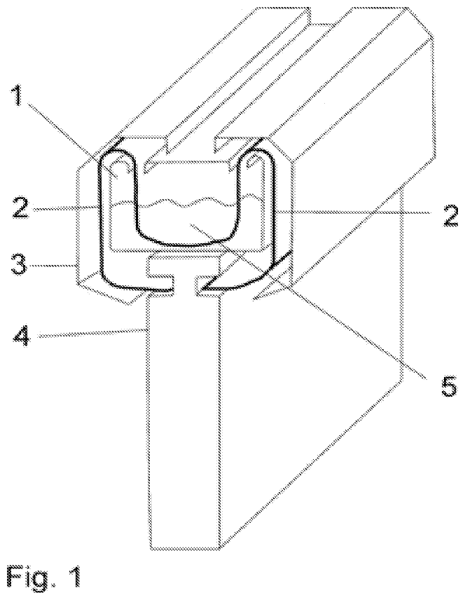

The proposed solution for the irrigation of vertical greenery is based on the principle of capillary water transport as shown schematically in FIG. 1.

The irrigation medium, for example irrigation water, to which nutrients are added continuously or at intervals, is provided in a water storage container (1) which is arranged above the vertical body of vegetation (4) to be irrigated.

A constant water level is maintained via a commercially available float-controlled metering of the water inlet or time-controlled with the help of a bypass pipe that extends within and along the water storage container (1) and touches it through appropriately sized holes.

When the water level in the water storage container (1) reaches the height of the holes/openings/bores in the bypass pipe, the excess water is discharged, for example, into the water collection basin or directly.

This prevents the water storage container (1) from overfilling/overflowing. This achieves a constant, adjustable water level in the water storage container (1), which is not shown in FIG. 1. A capillary-active water conductor (2) with a fibrous structure is inserted into the water storage container (1), which guides the irrigation medium (5) beyond the edge of the storage container (1) into the vertical vegetation body (4). The capillary water transport occurs by using, for example, a fleece as the capillary-active water conductor (2), which has sufficient fiber density and the resulting capillary system in the fleece creates the required capillarity and the water rises up in the fleece against the forces of gravity and is directed beyond the boundary of the water storage container (1) into the vegetation body (4) located underneath. It was found that geotextile nonwovens (e.g. B. recycled fleeces) with a grammage of 50 to 2500 g/m² have the required capillarity to stably supply vertical greenery with water.

With different water requirements, which result from different types of vegetation and vegetation areas, capillary-active nonwovens with different grammages can be used, with a plurality of different capillary-active water conductors being usable within an irrigation device through the use of different geotextile nonwovens. The water storage container (1) and the capillary-active water conductor (2) are covered with a protective cover (3).

In FIG. 1, the vegetation body (4) to be irrigated is shown as a free-standing, double-sided (both side surfaces of the vegetation body (4)) vertical greenery, as can be used, for example, as a room divider indoors.

It can consist of a supporting structure with vegetation support layers attached on both sides (e.g. B. geotextile fleece mats). The at least one capillary-active water conductor (2) can be in contact with the vegetation support layers (for example attached to them) or can itself be part of the vegetation support layer. The vegetation body (4) can be of any size, but is preferably provided as a room divider in interior greenery at a height of approximately 200 cm. With an assumed width of the vegetation body (4) of 300 cm, the irrigation device is preferably dimensioned so that the water storage container (1) and in particular the capillary-active water conductor (2) cover the entire width of the vegetation body (4). The use of the capillary-active fleece means that the vegetation body (4)—in contrast to point-shaped drip irrigation—is supplied with water over a wide area and thus a high level of uniform irrigation is achieved across the area.

Given the exemplary height of the vegetation body (4) of 200 cm, it has proven to be expedient to use a geotextile fleece (recycled fleece, etc.) with a grammage of 800 g/m² as the capillary-active water conductor (2). The irrigation medium (5) flows through the capillary-active water conductor (2) by means of a capillary effect and then vertically through the vegetation body (4) into the foot of the vegetation body (4). Here the excess water can be collected and returned to the water storage container (1), so that an irrigation cycle can be created.

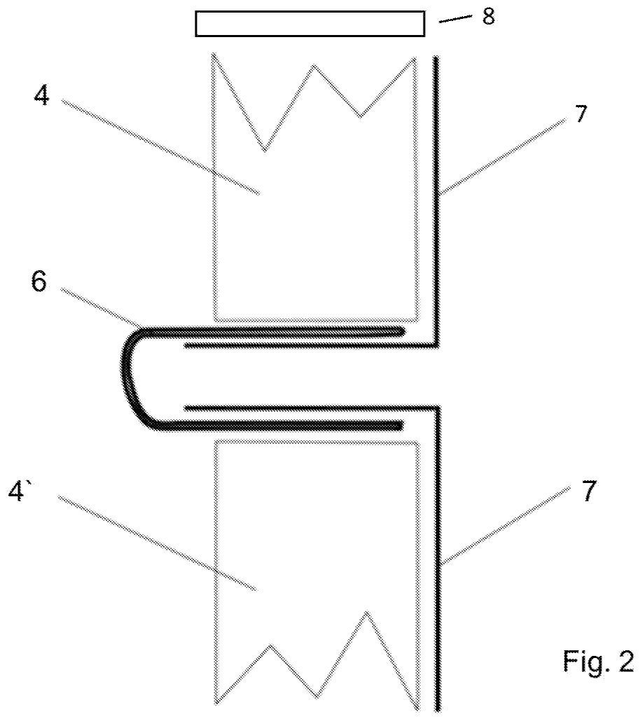

FIG. 2 shows a schematic representation of an irrigation device (8) with a plurality of vegetation bodies (4, 4′), which are vertically connected to one another via a capillary-active bridge (6).

The vegetation bodies (4, 4′) are arranged vertically to one another in a holding device (7).

However, it should be pointed out that a horizontal arrangement of the vegetation bodies (4, 4′) is also conceivable. According to FIG. 2, all vegetation bodies (4, 4′) are supplied with irrigation medium by a single irrigation device (8). The vegetation body (4) is supplied with irrigation medium directly through the irrigation device (8) and the other vegetation body (4′) is supplied with irrigation medium through the capillary-active bridge (6). In the exemplary embodiment of FIG. 2, the capillary-active bridge (6) is located outside the vegetation bodies (4, 4′), but it is also conceivable that the capillary-active bridge (6) at least partially protrudes into the vegetation bodies (4, 4′) and/or with it the substrate of the vegetation bodies (4, 4′) is in direct contact. The holding device (7) can be cassettes in which the vegetation bodies (4, 4′) can be inserted. The cassettes can, for example, have a size of 50×50 cm and a depth of 5 cm.

With a vertical arrangement of the vegetation bodies (4, 4′)—as shown in FIG. 2—for example 2 to 40, preferably 5 to 20, more preferably 10 to 14 vegetation bodies (4, 4′) can be irrigated by a single device for irrigation (8) and be supplied with irrigation medium through a plurality of capillary-active bridges (6). In the exemplary embodiment according to FIG. 2, the supply through the capillary-active bridges takes place in a cascade manner, that is, the next vegetation body (after the vegetation body 4′, not shown in FIG. 2) receives the irrigation medium via a further capillary-active bridge (not shown in FIG. 2), which was promoted by the capillary-active bridge (6) above. Both with a vertical arrangement of the various vegetation bodies (4, 4′) and with a horizontal arrangement of the various vegetation bodies (4, 4′), a plurality of capillary-active bridges (6) can also be supplied with irrigation medium via a type of pyramid system.

In the pyramid system, a first body of vegetation is supplied with irrigation medium by the irrigation device. Starting from this first vegetation body, a large number of further vegetation bodies are supplied with the irrigation medium via capillary-active bridges, with all capillary-active bridges starting at this first vegetation body. The other vegetation bodies can be arranged vertically offset from one another or horizontally on the same level with one another. Of course, an arrangement of vegetation bodies and capillary-active bridges can also be provided, which represents a combination of a cascade and pyramid system. Preferably, the body of vegetation that is irrigated by the irrigation device is arranged vertically above the bodies of vegetation that are irrigated via the capillary-active bridges.

### REFERENCE SYMBOL LIST

1 Water storage container
2 Capillary-active water conductor
3 Protective cover
4 Vegetation bodies
5 Irrigation medium
6 Capillary active bridge
7 Holding device
8 Irrigation device

1. A device for irrigating vertical greenery comprising:
at least one water storage container arranged vertically above a vegetation body; and
at least one capillary-active water conductor arranged therein, which protrudes from the water storage container and protrudes into the vegetation body.

2. The device for irrigating vertical greenery according to claim 1, wherein the at least one capillary-active water conductor has a length which corresponds to less than a third of the length of the vegetation body.

3. The device for irrigating vertical greenery according to claim 1, wherein the at least one capillary-active water conductor has a length which corresponds to the length of the vegetation body.

4. The device for irrigating vertical greenery according to claim 1, wherein the at least one capillary-active water conductor has a width which corresponds to the width of the vegetation body.

5. The device for irrigating vertical greenery according to claim 1, wherein at least a portion of the at least one capillary-active water conductor neither protrudes in the vegetation body nor protrudes into the at least one water storage container.

6. The device for irrigating vertical greenery according to claim 1, wherein the at least one capillary-active water conductor is a geotextile fleece with a grammage of 50 to 2500 g/m².

7. The device for irrigating vertical greenery according to claim 1, wherein the at least one capillary-active water conductor has a grammage of 800 g/m².

8. The device for irrigating vertical greenery according to claim 1, wherein the at least one water storage container and at least partially the at least one capillary-active water conductor are covered with a protective cover.

9. The device for irrigating vertical greenery according to claim 8, wherein the protective cover is movably provided on the irrigation device and/or a vegetation body.

10. The device for irrigating vertical greenery according to claim 1, wherein the irrigation device has a collecting tray for the excess irrigation fluid.

11. The device for irrigating vertical greenery according to claim 10, wherein the irrigation device has a pump which pumps the irrigation fluid from the collecting tray into the at least one water storage container.

12. The device for irrigating vertical greenery according to claim 1, wherein the at least one capillary-active water conductor is a one-piece textile material, the two ends of the textile material being connected to one another.

13. The device for irrigating vertical greenery according to claim 1, wherein the at least one water storage container and/or the protective cover and/or the at least one capillary-active water conductor from the irrigation device and/or can be reversibly removed from a body of vegetation.

14. The device for irrigating vertical greenery according to claim 13, wherein the removal of the removable parts is carried out by a horizontal movement of the removable parts parallel to the width of a vegetation body.

15. The device for irrigating vertical greenery according to claim 1, wherein the device has at least one capillary-active bridge with which another vegetation body can be irrigated by means of the device for irrigating vertical greenery.

16. The device for irrigating vertical greenery according to claim 15, wherein the at least one capillary-active bridge is arranged outside the vegetation bodies or is at least partially arranged within a vegetation body.

17. A vertically plantable vegetation body comprising a device for irrigating vertical greenery according to claim 1.
